(19) United States
(12) Patent Application Publication
(10) Pub. No.: US 2013/0000658 A1
(43) Pub. Date: Jan. 3, 2013

(54) Combination Toothbrush, Floss Dispenser and Tongue Scraper

(75) Inventors: Quang Nguyen, Harvey, LA (US); Nam Hai Nguyen, Marrero, LA (US); Nam Hoai Le-Nguyen, Harvey, LA (US)

(73) Assignee: MIZARU ENTERPRISES, LLC, Harvey, LA (US)

(21) Appl. No.: 13/175,791

(22) Filed: Jul. 1, 2011

(51) Int. Cl. A46B 15/00; A61C 15/04

(52) U.S. Cl. 132/200; 132/309

(57) ABSTRACT

A combination toothbrush, floss dispenser and tongue scraper apparatus is provided. The apparatus comprises an elongated member having a first end with a brush head and having an opposite second end with a tongue scraper and having an inner cavity with a floss dispenser disposed within the member between the brush head and the tongue scraper. A lid is hinged at a substantially central section of the elongated member for enclosing or providing access to the inner cavity by movement between open and closed positions relative to the inner cavity.

### BACKGROUND

1. Field of the Invention

The present invention relates generally to a toothbrush, floss dispenser and tongue scraper, and more particularly, to a combination toothbrush and tongue scraper with a floss dispenser in its handle and to a method of using it.

2. Description of Related Art

Good oral health is vital to a person's overall wellbeing. It is well understood that good oral hygiene techniques include brushing and flossing teeth, which reduce the risk of tooth decay and gum disease. It is also well understood that daily scraping of the tongue reduces harmful bacteria and sulfur compounds in the mouth, thereby significantly inhibiting plaque formation on the teeth and promoting good oral hygiene. Accordingly, efforts have long been made and directed to devices that facilitate good dental care.

Prior art discloses a combination of toothbrush and dental floss dispenser, wherein dental floss is stored and dispensed from the end of a handle of a toothbrush such as disclosed in U.S. Pat. No. 1,312,896, U.S. Pat. No. 1,738,389, U.S. Pat. No. 3,890,986, U.S. Pat. No. 4,821,752, U.S. Pat. No. 5,676,167 and U.S. Pat. No. 7,201,172. However, such devices do not provide for or accommodate a tongue scraper for the cleaning of the user's tongue. The prior art also discloses a number of tongue scrapers or cleaning devices but each has limitations and disadvantages. Representative examples of them include U.S. Pat. No. 5,709,004 and U.S. Pat. No. 7,310,846 which disclose a toothbrush and tongue cleaner device. Such devices are complex and do not provide for or accommodate floss dispensing.

A need therefore exists for a combination toothbrush, dental floss dispenser and tongue scraper apparatus providing efficient and cost effective oral hygiene care.

An objective of the present invention is to provide an apparatus that reduces the number of separate devices that are necessary for maintaining good oral hygiene.

An objective of the present invention is to provide an apparatus that makes brushing, flossing and tongue scraping activities convenient by having the brush, the floss and the scraper in one apparatus, to promote good dental care.

A further objective of the present invention is to provide an apparatus which is easy to use and manufacture.

Embodied methods and devices of present invention achieve aforementioned objects and goals by making brushing, flossing and tongue scraping activities convenient by providing the brush, the floss dispenser and the tongue scraper in one apparatus, thereby effectively replacing multiple separate devices that are necessary for maintaining good oral hygiene.

To overcome the limitations of the prior art described above, and to overcome other limitations that will become apparent upon reading and understanding the present specification, embodiments of the present invention provide a cost effective method and simplified means for brushing, flossing and tongue scraping activities.

As will be described in more detail below, embodiments of the present invention provide a structure, method and combination of scope and function completely different than the prior art.

### SUMMARY

The following present a simplified summary of the present disclosure in a simplified form as a prelude to the more detailed description that is presented herein.

Embodiments of the present invention are generally directed to a combination toothbrush, tongue scraper and floss dispenser apparatus and to a method of using it.

In one aspect, the present invention relates to a combination toothbrush, floss dispenser and tongue scraper apparatus, comprising an elongated member having opposite first and second ends and an inner cavity disposed between the first and second ends. A brush head is disposed at the first end and includes a plurality of bristles. A normally planar tongue scraper is disposed at the second end and is adapted to scrape the tongue of a user. A floss dispenser is disposed within the inner cavity that is disposed within the member between the first end which has the brush head and the second end which has the tongue scraper, enabling floss to be efficiently dispensed from a device providing a toothbrush and tongue scraper.

In one embodiment of the present invention, the elongated member may have a hinged lid providing access to the floss dispenser by movement between open and closed positions relative to the inner cavity. In a preferred embodiment, the tongue scraper has a generally convexly arcuate outer edge, which most preferably has a plurality of serrations for efficient scraping of the user's tongue. In yet another embodiment, the tongue scraper may have a generally linear outer edge which is substantially orthogonal in direction to the member. Such a generally linear outer edge preferably has serrations.

Preferably, the elongated member includes a textured gripping means disposed between the brush head and the inner cavity as well as disposed between the inner cavity and the tongue scraper for securing the user's hold of the member between the thumb and a finger during use.

Preferably, an embodiment of the combination toothbrush, floss dispenser and tongue scraper apparatus is a single-pieced molded construction, enabling cost effective and efficient manufacture.

In another aspect, the present invention relates to an improved toothbrush, comprising an elongated member having a first end and an opposite second end and an inner cavity disposed within the member at a substantially central section between the first end and second end of the member. A lid is hinged to the substantially central section of the member for enclosing or providing access to the inner cavity by movement between open and closed positions relative to the inner cavity. The inner cavity comprises a retaining wall means for containing floss, an aperture through said retaining wall means for dispensing floss and a floss cutting means positioned proximate to the aperture. A brush head is disposed at the first end and includes a plurality of bristles. A normally planar tongue scraper is disposed at the second end which is opposite the first end and is adapted to scrape the tongue of a user. Preferably, an embodiment of the improved toothbrush is a single-pieced molded construction, enabling cost effective and efficient manufacture.

In one embodiment, the hinged lid further comprises an engaging means protruding radially from the lid to engage a slot disposed within a wall of the substantially central section of the member when the lid is in a closed position, enabling the lid to snap or secure with a snug fit when closed. Preferably, the hinged lid includes an inner protrusion extending radially with a lip for engaging a slot disposed within the wall of the substantially central section of the member for rigidly securing the lid in a closed position.

In a preferred embodiment, a spool of floss material is disposed within the inner cavity, enabling an efficiently large quantity of floss material to be dispensed therefrom. Preferably, the elongated member of an embodiment of the present invention is fabricated from resilient material, such as plastic, rubber, polymeric composites, Kevlar, carbon fiber and the like.

In yet another aspect, the present invention relates to a method for dispensing dental floss from within a combination toothbrush, floss dispenser and tongue scraper apparatus, where the method comprises the steps of providing a combination toothbrush, floss dispenser and tongue scraper apparatus comprising an elongated member having a brush head end and a tongue scraper end opposite the brush head end and having a lid hinged around an inner cavity containing a compartment with an aperture disposed within the member at a substantially central section between the brush head end and the tongue scraper end of the member, where said inner cavity contains a supply of dental floss material within the compartment. A user grips the member between the central section and the brush head end or between the central section and the tongue scraper end, and the user opens the hinged lid to access the dental floss and pulls dental floss from the compartment through the aperture.

### BRIEF DESCRIPTION OF THE DRAWINGS

Illustrative embodiments of the present invention are described herein with reference to the accompanying drawings, in which:

FIG. 1 is a perspective view of an exemplary combination toothbrush, floss dispenser and tongue scraper showing an inner cavity with the floss dispenser.

FIG. 2 is a front elevation view thereof.

FIG. 3 is a rear elevation view thereof.

FIG. 4 is a left elevation view thereof.

FIG. 5 is right elevation view thereof.

FIG. 6 is a top plan view thereof.

FIG. 7 is a bottom plan view thereof showing a hinged lid in an open position.

FIG. 8 is a perspective view of an exemplary combination toothbrush, floss dispenser and tongue scraper having an inner cavity with a floss dispenser, showing a hinged lid in a closed position.

FIG. 9 is a front elevation view thereof.

FIG. 10 is a rear elevation view thereof wherein the exemplary tongue scraper includes serrations.

FIG. 11 is a left elevation view thereof.

FIG. 12 is a right elevation view thereof showing an exemplary grasp depression on a hinged lid in a closed position.

FIG. 13 is a top plan view thereof.

FIG. 14 is a bottom plan view thereof.

### DETAILED DESCRIPTION

Persons of ordinary skill in the art will realize that the following disclosure is illustrative only and not in any way limiting. Other embodiments of the disclosure will readily suggest themselves to such skilled persons having the benefit of this disclosure.

The present disclosure is generally directed to embodiments of a combination toothbrush and tongue scraper with a floss dispenser in a handle between the brush and the tongue scraper.

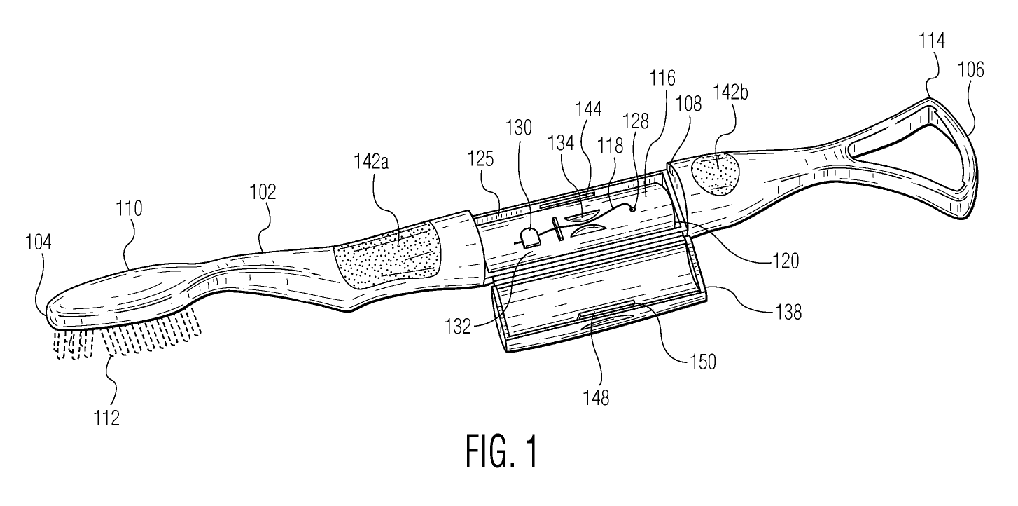

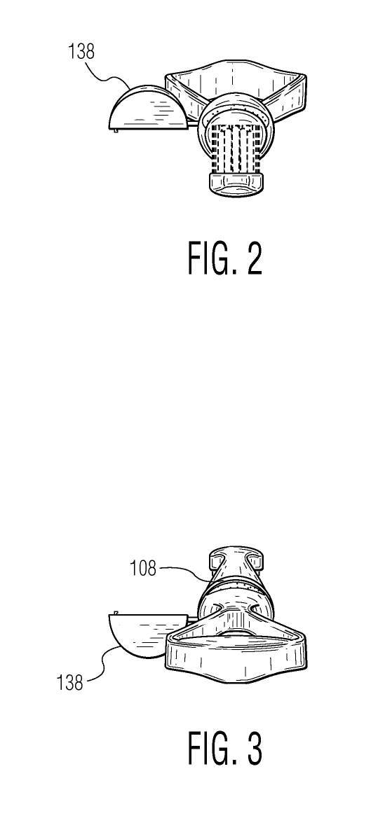

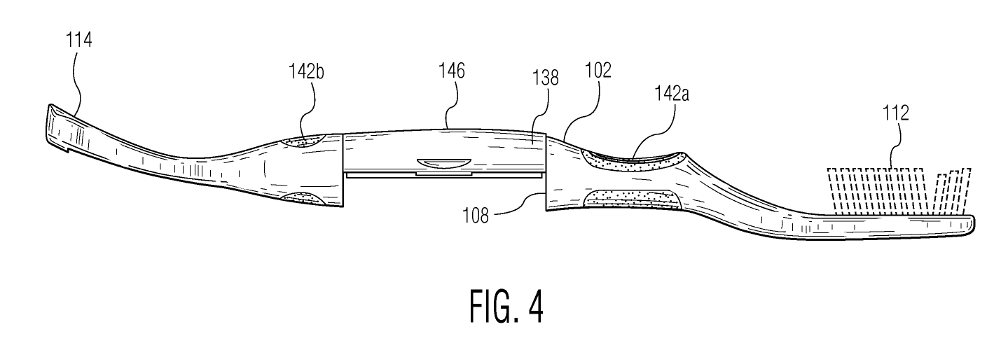

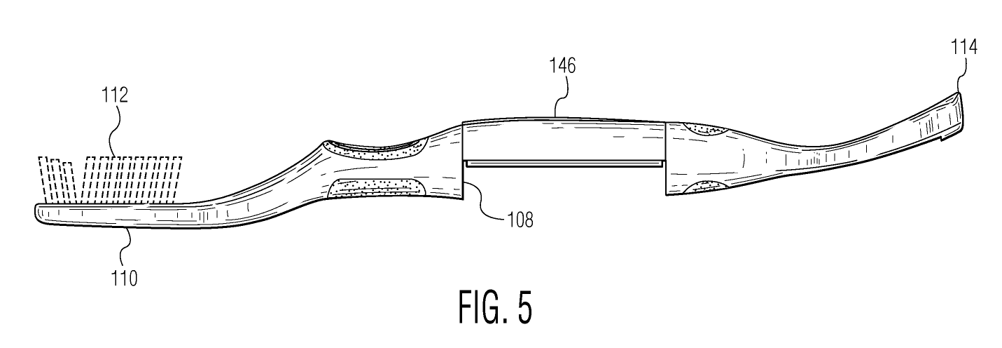

Referring initially to FIG. 1, the basic constructional details, principles of operation and arrangement of an exemplary combination toothbrush, floss dispenser and tongue scraper apparatus 100 according to a preferred embodiment of the present invention will be discussed.

In FIG. 1, a combination toothbrush, tongue scraper and floss dispenser apparatus 100 according to a preferred embodiment of the present invention is provided. In FIG. 1, the combination toothbrush, tongue scraper and floss dispenser apparatus 100 comprises an elongated member 102 having opposite first 104 and second 106 ends and an inner cavity 108 disposed between the first 104 and second 106 ends. A brush head 110 is disposed at the first end 104 and includes a plurality of bristles 112. A normally planar tongue scraper 114 is disposed at the second end 106 and is adapted to scrape the tongue (not shown) of a user. A floss dispenser 116 is disposed within the inner cavity 108 disposed within the member 102 between the first 104 and second 106 ends for dispensing floss 118 at a point between the brush head 110 and tongue scraper 114. The elongated member 102 is preferably fabricated with flexible plastic and rubber.

The floss dispenser 116 preferably includes a retaining wall means such as a concave wall 120 having first 122 and second 124 ends each connected to the inner surface 126 of inner cavity 108 of the elongated member 102 for the containment of floss 118, wherein said concave wall 120 includes an aperture 128 in relative proximity to a floss cutter 130 preferably disposed on the exposed surface 132 of said concave wall 120 within the inner cavity 108 such that floss 118 may be advanced through said aperture 128 and cut to length by the floss cutter 130. The retaining wall means may alternatively be a generally planar wall or a convex wall rather than being concave in shape, and it may be fabricated as part of the elongated member 102 in as single-piece construction or may be fabricated separate from the elongated member 102 and snapped into place with a snug fit within the inner cavity 108 of the elongated member. Moreover, in a preferred embodiment, the retaining wall means such as concave wall 120 extends axially the entire length of the inner cavity 108.

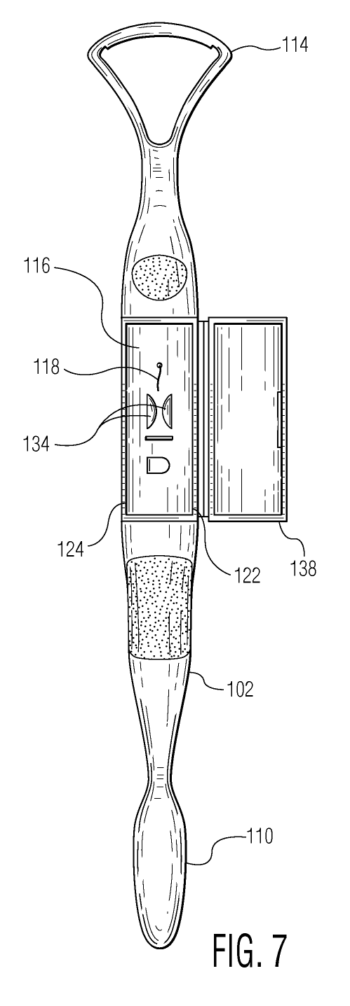

As illustrated in FIG. 1 and FIG. 7, the concave wall 120 preferably includes depressions 134 and a support wall 136 disposed on the exposed surface 132 of the concave wall 120 in between and in general axial alignment with the aperture 128 and floss cutter 130, to facilitate grasping of floss material 118 advanced out of said aperture 128 and toward said floss cutter 130.

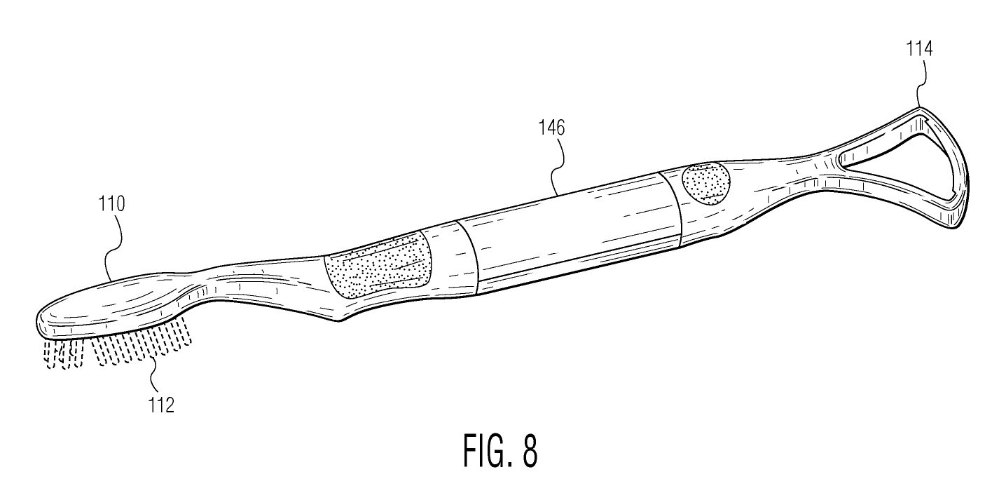

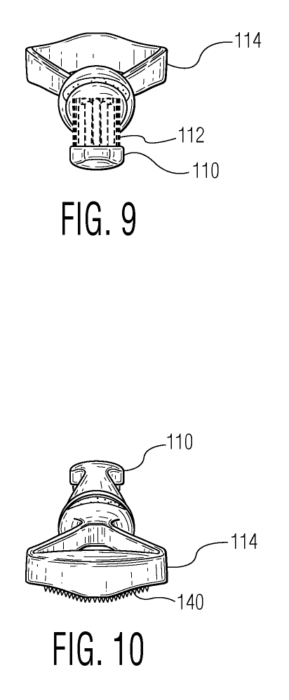

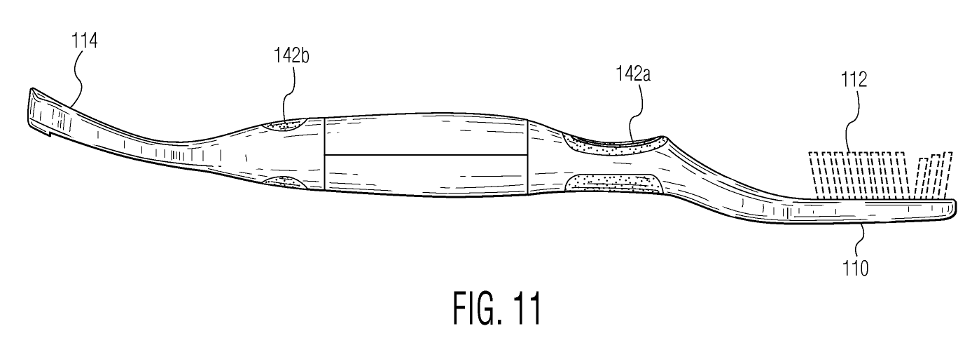

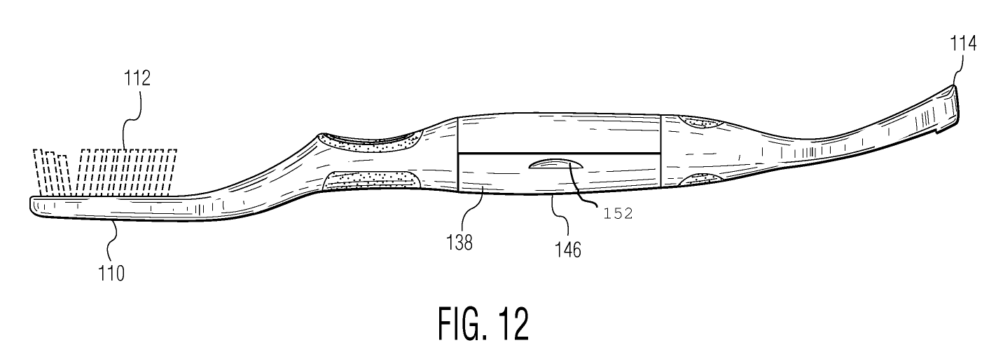

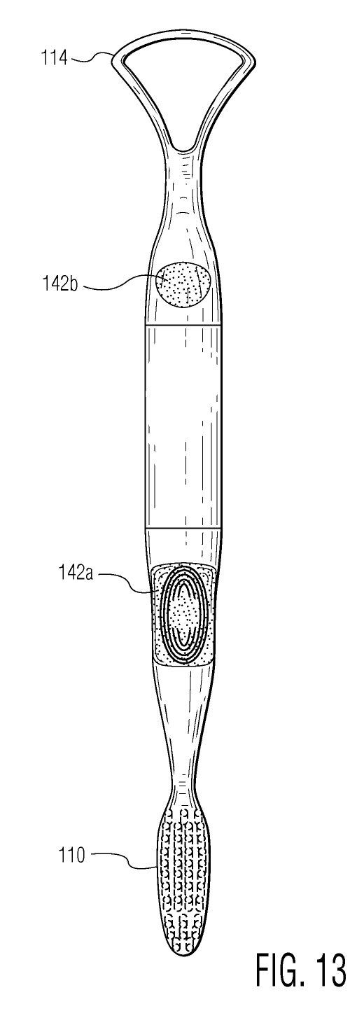

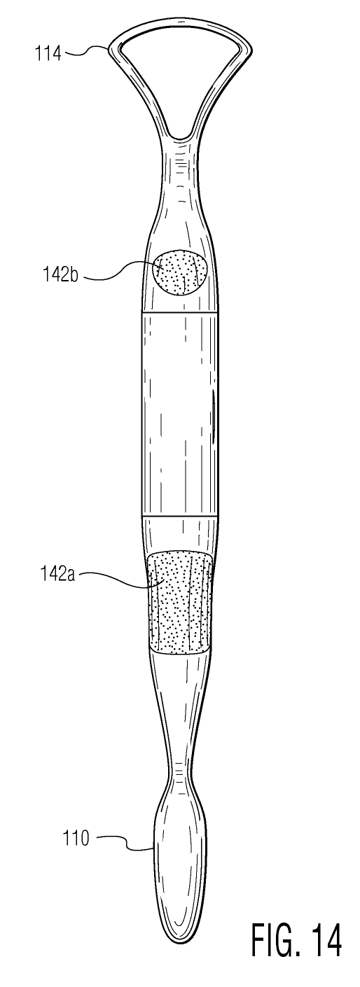

Preferably, the elongated member 102 of the combination toothbrush, floss dispenser and tongue scraper apparatus 110 comprises a hinged lid 138 providing access to the floss dispenser 116 by movement between open and closed positions (FIGS. 1 and 8) relative to the inner cavity 108. FIG. 1 illustrates a perspective view of an exemplary combination toothbrush, floss dispenser and tongue scraper apparatus 100 wherein the hinged lid 138 is in an open position. FIG. 8 illustrates a perspective view of an exemplary combination toothbrush, floss dispenser and tongue scraper apparatus 100 wherein the hinged lid 138 is in a closed position. FIG. 12 illustrates a right elevation view of the exemplary combination toothbrush, floss dispenser and tongue scraper apparatus 100 wherein the hinged lid 138 is in the closed position.

As an alternative embodiment, the hinged lid 138 may serve as the retaining wall means for enclosing floss material 118 within the inner cavity 108 of the elongated member 102. In such an alternative embodiment, the hinged lid 138 would preferably include an aperture through which floss could be advanced, and a floss cutter could be fitted on exterior surface of the hinged lid 138 or fitted elsewhere on the elongated member 102.

In a preferred embodiment, the retaining wall means is a removable wall such that the combination toothbrush, floss dispenser and tongue scraper apparatus 110 may be refilled with floss 118 multiple times.

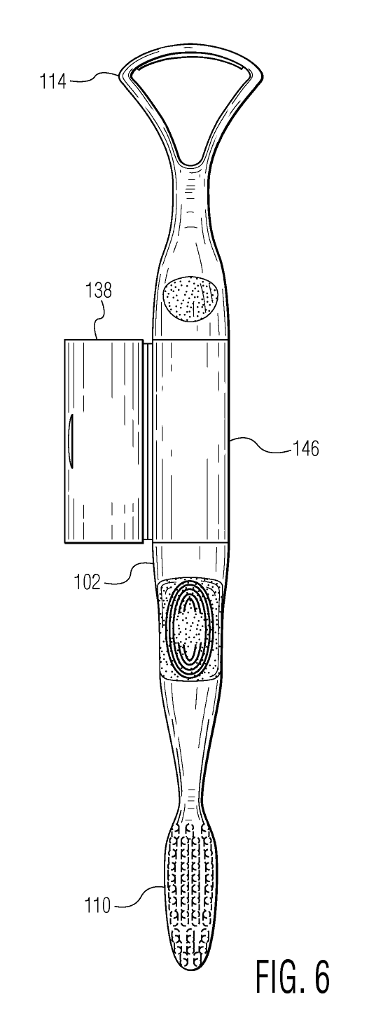

Referring to FIG. 6, in a preferred embodiment, the tongue scraper 114 has a generally convexly arcuate outer edge, which most preferably has a plurality of serrations 140 (FIG. 10) for efficient scraping of the user's tongue. The serrations 140 are generally teeth-like in orientation. The center of the generally convexly arcuate outer edge of the tongue scraper 114 is preferably substantially orthogonal (perpendicular) in direction to the member. In yet another embodiment, the tongue scraper 114 may have a generally linear outer edge which is substantially orthogonal in direction to the elongated member 102; and such a generally linear outer edge preferably has serrations. It may be appreciated that the tongue scraper 114 may alternatively have a generally concavely arcuate outer edge with or without serrations.

The tongue scraper 114 is preferably double-sided tongue scraper, enabling a user to scrape the user's tongue with either side of the tongue scraper 114. For instance, in one embodiment, the upper side of the tongue scraper 114 may be generally straight while the lower side of the tongue scraper 114 may have serrations 140.

In a preferred embodiment, the elongated member 102 comprises a textured surface areas 142a, 142b disposed between the brush head 110 and the inner cavity 108 as well as between the inner cavity 108 and the tongue scraper 114 for securing the user's hold of the elongated member 102 between the thumb and a finger during use. A preferred gripping surface 142a, 142b is fabricated with rubber or plastic.

In manufacture, the elongated member 102 of an embodiment of the combination toothbrush, floss dispenser and tongue scraper apparatus 100 is a single-pieced molded construction, enabling cost effective and efficient manufacture.

In a preferred embodiment of the present invention, the lid 138 is hinged to the substantially central section 146 of the member for enclosing or providing access to the inner cavity by movement between open and closed positions relative to the inner cavity 108.

The opening of the inner cavity 108 is preferably lined with a relatively thin rubber seal to facilitate resistance to water and moisture entering the inner cavity 108 when the lid 138 is in a closed position. In a closed position, the hinged lid 138 reduces the risk of contamination of the floss 118.

The hinged lid 138 further comprises an engaging means protruding radially from the lid 138 to engage a slot 144 disposed within a wall of the substantially central section 146 of the member 102 when the lid 138 is in a closed position, enabling the lid 138 to snap into place with a snug fit when closed. Preferably, the hinged lid 138 includes an inner protrusion 148 extending radially with a lip 151 for engaging the slot 144 disposed within the wall of the substantially central section 146 of the member 102 for rigidly securing the lid 138 in a closed position. The hinged lid 138 preferably includes a depression 152 along its exterior surface to facilitate better gripping of the lid 138 when opening it.

It is also noted that in one embodiment the generally convexly arcuate outer edge of the tongue scraper 114 may be configured to open a capped bottle. In such an embodiment, the generally convexly arcuate outer edge of the tongue scraper 114 is preferably constructed of a durable material such as stainless steel, Kevlar, carbon fiber or glass fiber and used to pop a bottle cap off of a bottle by engaging a bottle cap with the tongue scraper 114 at a first position at a substantially 45 degree angle respective to the central vertical axis of the bottle and prying off the bottle top by rotatably lifting the elongated member 102 in an upward manner to a second position respective to the first position.

In yet another aspect, the present invention relates to a method for dispensing dental floss 118 from within a combination toothbrush, floss dispenser and tongue scraper apparatus 100, where the method comprises the steps of providing a combination toothbrush, floss dispenser and tongue scraper apparatus 100 comprising an elongated member 102 having a brush head end 104 and a tongue scraper end 106 opposite the brush head end 104 and having a lid 138 hinged around an inner cavity 108 containing a compartment with an aperture 128 disposed within the member 102 at a substantially central section 146 between the brush head end 104 and the tongue scraper end 106 of the member 102, where said inner cavity 108 contains a supply of dental floss material 118 within the compartment. A user preferably grips the member 102 between the central section 146 and the brush head end 104 or between the central section 146 and the tongue scraper end 106, and the user opens the hinged lid 138 to access the dental floss 118 and pulls dental floss 118 from the compartment through the aperture 128.

It will be apparent to persons skilled in the relevant art that various changes in form and detail can be made without departing from the spirit and scope of the invention. While various embodiments of the present invention have been described above, it should be understood that they have been presented by way of example only, and not limitation. Thus, the breadth and scope of the present invention should not be limited by any of the above-described exemplary embodiments, but should only be defined in accordance with the following claims and their equivalents. All patents and publications discussed herein are incorporated in their entirety by reference thereto.

1. A combination toothbrush, floss dispenser and tongue scraper apparatus, comprising:
an elongated member having opposite first and second ends and an inner cavity disposed between the first and second ends:
a brush head disposed at the first end and having a plurality of bristles;
a normally planar tongue scraper disposed at the second end and adapted to scrape the tongue of a user; and
a floss dispenser and floss cutter disposed within the inner cavity disposed within the member between the first and second ends for dispensing and cutting floss at a point between the brush head and tongue scraper.

2. The combination toothbrush, floss dispenser and tongue scraper apparatus of claim 1, the elongated, member having a hinged lid providing access to the floss dispenser by movement between open and closed positions relative to the inner cavity.

3. The combination toothbrush, floss dispenser and tongue scraper apparatus of claim 1, wherein the tongue scraper is a double-sided tongue scraper.

4. The combination toothbrush, floss dispenser and tongue scraper apparatus of claim 1, wherein a spool containing floss material is disposed within the inner cavity containing the floss dispenser.

5. The combination toothbrush, floss dispenser and tongue scraper apparatus of claim 1, the tongue scraper having a generally convexly arcuate outer edge.

6. The combination toothbrush, floss dispenser and tongue scraper apparatus of claim 1, the tongue scraper having a generally convexly arcuate outer edge, the center of the outer edge being substantially orthogonal in direction to the member.

7. The combination toothbrush, floss dispenser and tongue scraper apparatus of claim 1, the tongue scraper having a generally convexly arcuate outer edge having a plurality of serrations.

8. The combination toothbrush, floss dispenser and tongue scraper apparatus of claim 1, the tongue scraper having a generally linear outer edge.

9. The combination toothbrush, floss dispenser and tongue scraper apparatus of claim 1, the tongue scraper having a generally linear outer edge, the outer edge being substantially orthogonal in direction to the member.

10. The combination toothbrush, floss dispenser and tongue scraper apparatus of claim 1, the tongue scraper having a generally linear outer edge having a plurality of serrations.

11. The combination toothbrush, floss dispenser and tongue scraper apparatus of claim 1, further comprising a textured gripping means disposed between the brush head and the inner cavity for securing the user's hold of the member between the thumb and a finger during use.

12. The combination toothbrush, floss dispenser and tongue scraper apparatus of claim 1, further comprising a textured gripping means disposed between the tongue scraper and the inner cavity for securing the user's hold of the member between the thumb and a finger during use.

13. The combination toothbrush, floss dispenser and tongue scraper apparatus of claim 1, the floss dispenser having a retaining wall means for containing floss and having an aperture through said retaining wall means in relative proximity to a floss cutter means such that floss may be advanced through said aperture and cut to a length.

14. The combination toothbrush, floss dispenser and tongue scraper apparatus of claim 1, the tongue scraper having a generally convexly arcuate outer edge configured to open a capped bottle.

15. An improved toothbrush, comprising:
an elongated member having a first end and an opposite second end and an inner cavity disposed within the member at a substantially central section between the first end and second end of the member;
a lid hinged to the substantially central section of the member for enclosing or providing access to the inner cavity by movement between open and closed positions relative to the inner cavity, said inner cavity comprising a retaining wall means within said inner cavity for containing floss, an aperture through said retaining wall means for dispensing floss and a floss cutting means within said inner cavity positioned proximate to the aperture;
a blush head disposed at the first end and having a plurality of bristles; and
a normally planar tongue scraper disposed at the second end and adapted to scrape the tongue of a user.

16. The toothbrush of claim 15, wherein the lid further comprises an engaging means protruding radially from the lid to engage a slot disposed within the wall of the substantially central section of the member when the lid is in a closed position.

17. The toothbrush of claim 15 wherein the lid includes an inner protrusion extending radially with a lip for engaging a slot disposed within the wall of the substantially central section of the member for rigidly securing the lid in a closed position.

18. The toothbrush of claim 15, further comprising a spool of floss material disposed within the inner cavity.

19. The toothbrush of claim 15 wherein the tongue scraper is fabricated from resilient material.

20. A method for dispensing dental floss from within a combination toothbrush, floss dispenser and tongue scraper apparatus, comprising the steps of:
providing a combination toothbrush, floss dispenser and tongue scraper apparatus comprising an elongated member having a brush head end and a tongue scraper end opposite the brush head end and having a lid hinged around an inner cavity containing a compartment with an aperture and a floss cutter disposed within the member at a substantially central section between the brush head end and the tongue scraper end of the elongated member, said inner cavity containing a supply of dental floss material within the compartment;
gripping the member between the central section and either the brush head end or tongue scraper end;
opening the hinged lid to access the dental floss; and
put ring dental floss from the compartment through the aperture.

21. The combination toothbrush, floss dispenser and tongue scraper apparatus of claim 1, wherein the floss dispenser and the floss cutter are integrally connected together and removably disposed within the inner cavity of the member enabling replacement thereof.
